(19) United States
(12) Patent Application Publication
(10) Pub. No.: US 2003/0002243 A1
(43) Pub. Date: Jan. 2, 2003

(54) Mobile holster

(76) Inventors: Edward G. Newman, Fairfax Station, VA (US); Peter A. Ronzani, Los Gatos, CA (US); Peter S. Hong, Bristow, VA (US)

Correspondence Address: JAMES J. RALABATE, 5792 MAIN STREET, WILLIAMSVILLE, NY, 14221, US

(21) Appl. No.: 09/894,091

(22) Filed: Jun. 28, 2001

(51) Int. Cl. G06F 1/16

(52) U.S. Cl. 361/683; 361/686

(57) ABSTRACT

The present invention is directed to docking station or holster for wearable computers. The holster allows a user to carry a wearable computer and expands the peripheral capabilities of the underlying computer. The holster is not required for the computer to function as a wearable computer but rather extends its functionality. Optionally, the holster can be utilized with the same computer as a desktop docking station.

### INVENTION

The invention is directed to a wearable holster for a user supported computer wherein the computer can be selectively coupled to and supported by the holster. The holster expands the available power of the user supported computer with integral battery and connection for external battery and provides increase ports to the computer system. This application is related to commonly assigned co-pending application Ser. No. 09/850,929, filed in the U.S. P.T.O. May 8, 2001, entitled “Mobile Computer.”

### BACKGROUND OF THE INVENTION

Wearable computer systems are known in the art. Examples of such systems are commonly assigned U.S. Pat. Nos. 5,305,244 and 5,844,824, Newman I and Newman II respectively. The disclosures of these commonly assigned patents are hereby incorporated by reference into the present disclosure. Newman I and Newman II disclose a hands free user supported computer wherein the computer is worn or supported by the body of the user and can be activated through a variety of hands free means. The computer may be worn on the torso utilizing a separate head, wrist or other body worn display or the computer may be integral to the display itself. In either embodiment the display must be within the field of the view of the user and able to be used and supported at the same time. The benefit of such a computer system is that it allows remote workers to use a computer while they are working, such as to view a repair procedure, without the loss in productivity associated with using a laptop computer or otherwise portable computer system. A limiting factor of these computers however, is the power supply as well as the form factor. It is typically desirable to make the physical case as small as possible. However, this is done at the expense the size available for batteries and peripheral ports and card slots is comprised.

Also disclosing wearable computers are U.S. Pat. Nos. 5,285,398 (Janik I), 5,491,651 (Janik II), 5,581,492 (Janik III), 5,798,907 (Janik IV), 5,555,490 (Carroll I) and 5,572,401 (Carroll II). Each Janik patent discloses a belt computer containing the elements or components of a computer. For example, in Janik I, the plurality of computing elements are located on the belt and a flexible signal relaying means connects all of the elements for computing. A protective covering is used for enclosing said computer elements. In Janik II, a similar belt computer is described and claimed in which the signal relaying means, the length of which between any two computing elements, is greater than the length of the wearable member between any two computing elements. In each Janik patent, the flexible wearable computer is in the form of a relatively heavy belt comprising around its periphery sequentially positioned computer elements. In Janik I and II there is no provision for making the computer modular such that components of the computer may be selectively engaged or removed.

Carroll I and Carroll II disclose a wearable support and interconnection structure for a modular microcomputer system having a plurality of microcomputer cards housed in a plurality of microcomputer card pockets in a wearable garment. Examples of such garments include a pliable garment worn over the torso of the user (vest), a cap that fits snugly on the user's head or in the form of a belt. In one embodiment, the pockets are linked by a plurality of channels extending from pocket to pocket that secure an electronic linking system to the wearable garment. The linking system includes a plurality of flat flexible cables encasing flexible circuitry and microcomputer card connectors. A card connector opens into each pocket to receive a microcomputer card. Each connector is operable, coupled to the cables such that when microcomputer cards are placed in the connectors and provided with power, an operational microcomputer system is created. Like the systems of Newman I and II and Janik I and II there are no provisions for making the computer modular such that components of the computer may be selectively engaged or removed.

Also known in the art are computer docking stations. The docking stations are typically designed to permit connection to a laptop or notebook computer device. The benefit of the docking station is that all peripheral device connections including AC power supply, mouse, full size keyboard, external monitor, etc. are facilitated by the docking station. In this manner, a person may bring his laptop out of the office utilizing only the components inherent to the laptop and then when he returns to the office, he reconnects to the docking station using a single connector. He does not have to reconnect all his peripheral devices. The docking station may also have built in network interface card, CD-ROM drive, or additional hard disk drive(s).

U.S. Pat. No. 6,115,245 (herein after the '245 patent) teaches an exemplary docking station. The docking station of the '245 patent has a disk drive module incorporated therein which is capable of operatively receiving a disk drive. This docking station is designed to rest on a flat surface and to be used with a laptop computer. It is not designed to be coupled to a user supported computer device.

U.S. Pat. No. 6,216,195 (herein after the '195 patent) teaches a docking station for a notebook computer. The docking station includes a housing and an ejector device to assist in the disconnection between the computer and the docking station. Like the docking station of the '245 patent, the docking station is designed to rest primarily in the horizontal plane with respect to the surface it is disposed on. It is not designed to be portable or to couple to a user supported computer system.

U.S. Pat. No. 6,185,094 (herein after the '094 patent) teaches a vertically oriented docking station apparatus for a portable computer. Rather than sitting on a desktop in a horizontal plane, the docking station of the '094 patent receives the portable computer vertically so that it slides down a set of vertical rails and the connection between the computer and the docking station is reinforced by gravity. However, the docking station of the '094 patent is not designed to be wearable or to be coupled to a user supported computer.

Thus, there is a need for a computer holster or mobile docking station which is specifically designed for a wearable or user supported computer. For the purposes of this disclosure and claims the terms “computer holster” and “mobile docking station” will taken to be synonymous. Such a docking station should be able to be comfortably worn or supported by the body of a user and to possess restraining means to selectively restrain a wearable computer in a manner that will prevent accidental or unintended uncoupling of the computer from the docking station. Such a docking station should also expand on the available power supply integral to the wearable computer from which it is coupled.

### SUMMARY OF THE INVENTION

It is therefore an object of the invention to provide a computer holster which is devoid of the aforementioned problems and limitations.

It is another object of the invention to provide a computer holster which is designed to be supported by the body of a person while being used.

It is yet another object of the invention to provide a mobile docking station which is designed to couple with a user supported computer.

It is still another object of the invention to provide a mobile docking station which is mechanically and electrically coupled to a user supported computer.

It is an additional object of the invention to provide a computer holster which relies upon gravity to reinforce the coupling between the holster and the computer, wherein the gravity reinforcing is facilitated by vertical guide rails.

It is still an additional object of the invention to provide computer holster which expands the available power to the computer to which it is coupled.

These and additional objects of the present invention are accomplished generally by a body worn holster for use with a user supported computer.

Terms and Definitions:

For the purposes of the this disclosure and claims the following terms will be defined. The words wearable computer or user supported computer will be used interchangeably and will be taken to mean any computer which is functionally encased in a single enclosure and is worn on the body of a user, as opposed to Janik I and II wherein the basic essential components are encased in two or more enclosures connected by a flexible signal bus. This can include being supported by a belt, sash, vest, or other garment such that the user does not have to use his hands to support the computer. The computer itself will contain substantially the all the components of a general purpose computer including a CPU, memory, storage and bus, however it will not contain a monitor or display, but rather a connector to interface with such a device. The terms mobile holster, holster and mobile docking station will be used interchangeably and will be taken to mean a device for supporting a wearable computer as described above, which supports the computer physically, is also borne by the body of a user and provides additional but not required functionality to the wearable computer.

In one embodiment of the present invention, a user will attach the holster to a belt which is worn about the torso. The rear or body side of the holster will preferably have one or more belt loops or clips disposed thereon. In this manner the holster may be selectively attached or removed from the belt with a minimal amount of effort by the user and it may be comfortably attached on either the left or right side of the body. On the bottom side of the holster will sit a rechargeable power supply. This could be a lithium ion, lithium polymer, nickel cadmium or other suitable rechargeable power supply. The battery is attached to the holster in such a manner so that it may be selectively replaced while a computer is coupled to the holster. This will effectively enable hot swapping of the battery, assuming the computer itself possesses an internal battery or power supply. The computer holster will possess a vertical receiving structure comprised of a vertical and horizontal support. In the vertical plane sits a guide or guides which run downward normal to a rigid base at the bottom, disposed above the battery. A single electrical connector will reside at the bottom of the receiving structure so that the user supported computer may slide vertically into the receiving structure to facilitate electrical and physical interconnection. A reciprocal connector will reside on the bottom portion of the user supported computer and serve as the primary means of power and signal communication between the computer and the computer holster. Gravity will reinforce the connection between the computer and the computer holster. Additionally, it may be desirable to employ a mechanical fastening means to further secure the connection between the computer and the computer holster in the event that the user contorts his body such that the normal vertical plane has been rotated in excess of ninety degrees with respect to the horizontal and also to insure that the computer does not accidentally bounce out of the computer holster. The computer itself will possess a visual interface device connector on its top portion so that a variety of different visual interface devices may be utilized regardless of whether the computer is coupled to the holster. These interface devices may include head mounted displays, wrist mounted displays, neck hung displays, belt worn displays, hand held displays, desktop flat panel or CRT-type displays or other suitable display devices.

In another related embodiment, a person using a wearable computer may need to make use of communication devices, additional peripheral devices, extended battery, additional data storage devices or other devices which rely on an interface protocol which is not native to the base wearable computer. In this embodiment a user will couple and secure the wearable computer to the holster and then rely on the ports and connectors integral to the holster to expand the capability of the overall system created by the coupling of the two components. The holster itself will have at least one PCMCIA card slot which could be used for a variety of PCMCIA type devices including wireless modem and LAN cards, memory cards, or other suitable PC card based devices. This will permit wireless communication by the overall system of the holster and computer. Alternatively, the computer itself may possess its own integral or external communication means including cellular, radio, IrDA, Bluetooth, 802.11 or other suitable communications protocol. Additionally, the holster will possess a rechargeable power supply. It will also possess an connector for an auxiliary power supply. This could be another battery disposed elsewhere on the same belt which secures the holster or an AC power source. Other ports on the actual holster may include, USB ports, standard CRT video output port, IEEE 1394A, serial, parallel, or other suitable computer port. One of ordinary skill in the art will appreciate and understand that these ports and connectors described herein are cited for exemplary purposes only and that a variety of different ports and/or connectors may be used on the holster itself without departing in spirit or scope from the teaching of the present invention.

In yet another related embodiment, the holster may reside on a desktop and serve as a desktop docking station. The holster is designed so that there are no functional ports on the bottom face, which would be obscured by setting it on a flat surface. Additionally, the bottom face will be substantially flat in contour such that it will sit stably on a flat surface in a stable manner whether coupled or uncoupled to a wearable computer. Through this embodiment, a user may enjoy all the benefits of a docking station including having all peripheral devices connected to the docking station itself and not the computer. However, if the user needs to use the computer system remote to his desktop and to an AC power source and he needs some or all of the connectors integral to the holster or needs to maximize his battery life, he may take the holster off of the desktop and attach it to a belt transforming it into a wireless mobile docking station.

### BRIEF DESCRIPTION OF THE DRAWING FIGURES.

FIG. 1A illustrates an angled front view of an exemplary wearable computer present system.

FIG. 1B illustrates a straight front view of an exemplary wearable computer of the present system.

FIG. 1C illustrates a back view of an exemplary wearable computer of the present invention.

FIG 1D illustrates a top view of an exemplary wearable computer of the present invention.

FIG. 1E illustrates a bottom view of an exemplary wearable computer of the present invention.

FIG. 2 illustrates a plan view of the mobile holster mated with an exemplary wearable computer configured in a belt worn embodiment.

FIG. 3 illustrates a front view of the mobile holster of the present invention.

FIG. 4 illustrates a rear view of the mobile holster of the present invention.

FIG. 5 illustrates a over view of the electrical components within the mobile holster of the present invention.

### DETAILED DESCRIPTION OF THE INVENTION AND PREFERRED EMBODIMENTS

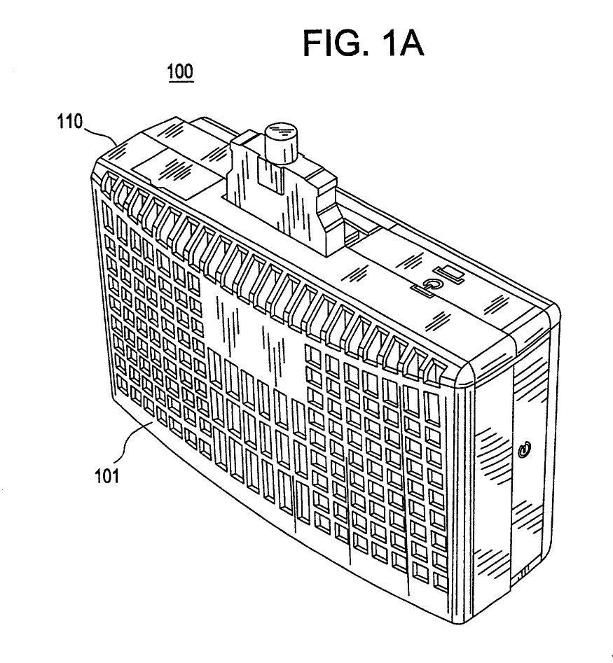

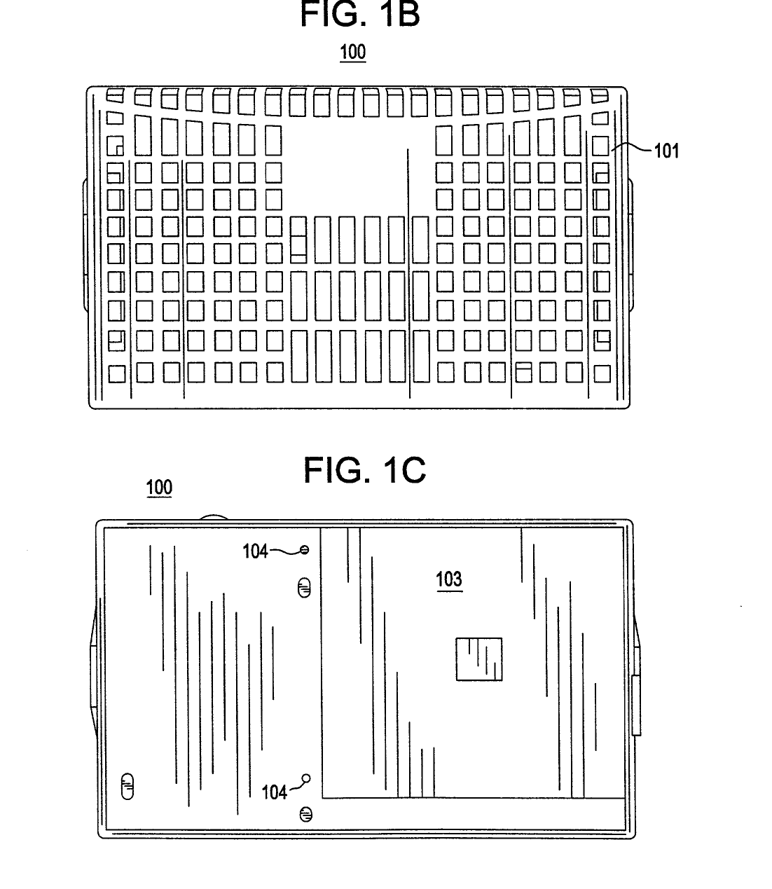

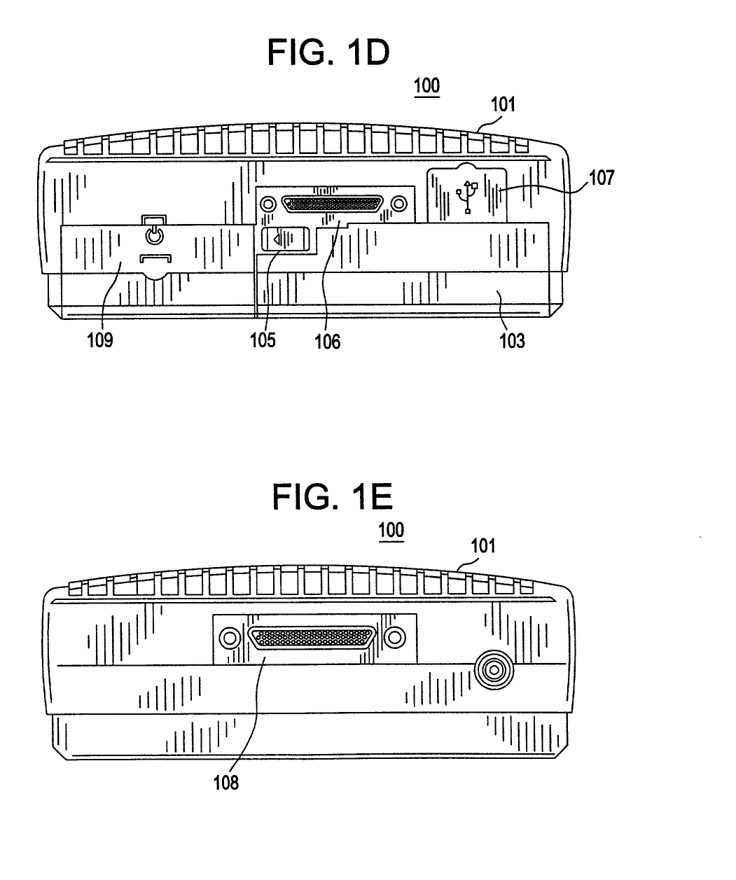

Discussion of the present invention will now be made with specific reference to the drawing figures. FIGS 1A-1E illustrate various views of an exemplary wearable computer to be used with the holster of the present invention. The computer itself 100 is comprised of a brick shaped casing 110 with a non-thermally conductive grille 101 on at least the front side to assist in heat dissipation and to provide a cool contact point for the user. Preferably the grille 101 is disposed on the face opposite to that which is closest to the user's body. FIG. 1B illustrates a direct front view of the computer 100 and grille 101. FIG. 1C illustrates a rear view of the computer 100 with integral removable battery 103 and guide rail screws 104 for attaching a guide rail which assists in the mating of the computer 100 with the mobile holster 200.

FIGS 1D and 1E illustrates top and bottom views of the exemplary computer 100 respectively. In FIG 1D various ports are disposed about the top face of the computer 100 including flash card slot 109, user interface port 106, USB port 107 and battery release switch 105. Release switch 105 is preferably a spring loaded switch, mechanical switch, or combination thereof which is either depressed or pushed to the side to activated the physical release mechanism such that the switch 105 is not prone to accidental or unintentional release due to inadvertent contact. On the opposing face, FIG. 1E, is a single electrical and power interface connector 108 for interfacing electronically with the holster 200. This connector 108 serves as the primary means of communication between the holster 200 relaying both information signals and consistent power.

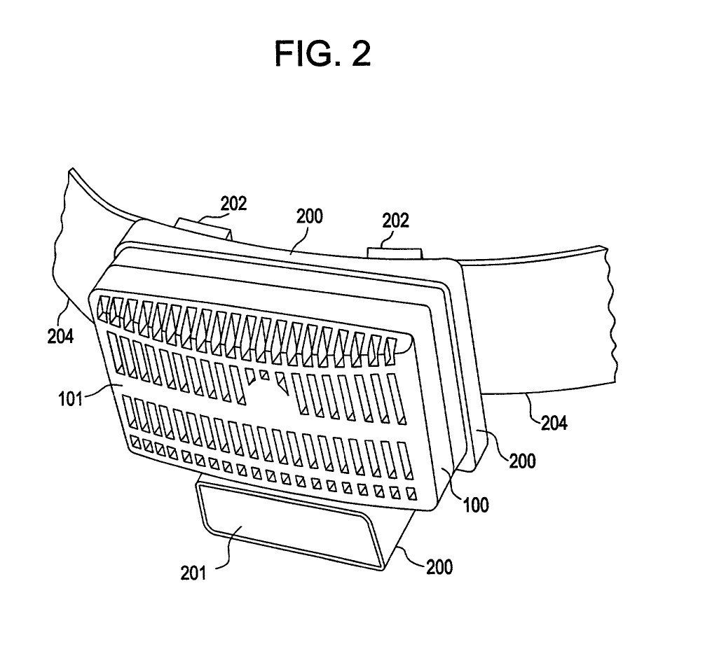

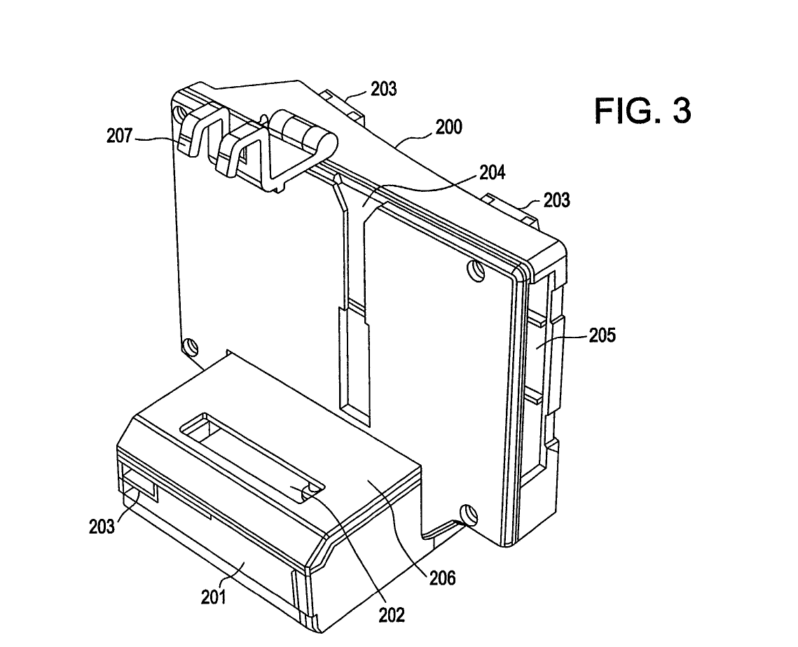

FIG. 2 illustrates the computer 100 mated with the mobile holster 200. On the rear face of the holster, 200, that is the face closed to the body, is a curved portion designed to fit ergonomically to the user's body. Disposed on this face is a fastening mechanism, specifically belt clips 202 which receive support belt 204 for making the holster 200 computer 100 system wearable. The holster 200 itself is generally shaped in a three dimensional L shape, as shown in FIG. 3. The bottom portion of the L contains an additionally battery 201 for supplying additional power to the computer 100.

FIG. 3 illustrates a detailed view of the front side of the holster 200. On one front vertical face of the holster is a guide and channel 204 for guiding the computer 100 into place on the docking station. The computer 100 will sit on the lower horizontal face 206 mating with connector 202, via reciprocal computer interface connector 108. Under the horizontal face 206 sits a removable battery 201 which is released by release switch 203. Optional stress relief clip 207 mounted on the holster 200 secures the user interface device connector to the computer 100 while the computer is attached to the holster 200 such that any stress on the cord will not be borne by the connector itself. A pair of belt loops 203 are integral to the holster 200 casing which permit the holster to be supported by torso belt 204. On one side face of the holster 200 is an opening to PCMCIA card slot 205. This permits insertion of a host of third party PC-type cards including communication cards, memory cards, network cards, GPS cards, and any other suitable PC-type card.

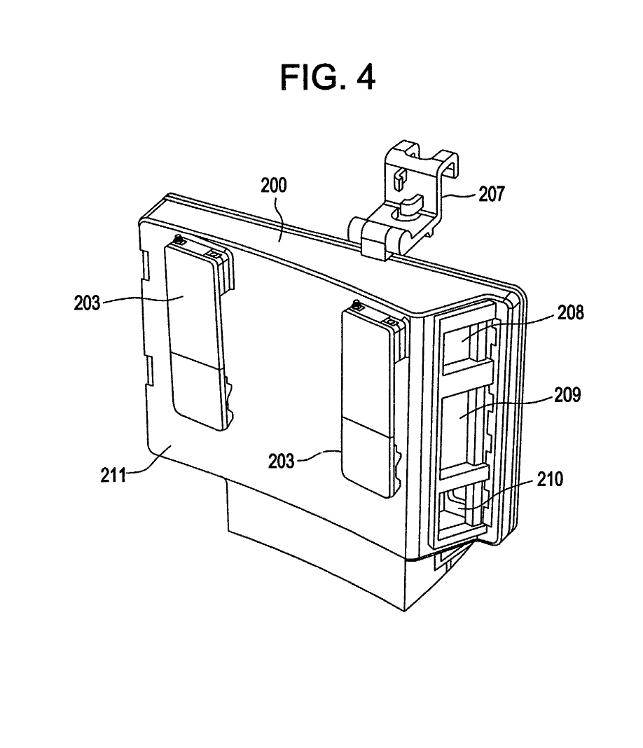

FIG. 4 illustrates a detailed view of the rear side of the holster 200. The rear face 211 is shaped concavely to make the holster fit more securely against the convexly curved portion of the wearer's hip or waist or any other suitable portion of the user's body. Belt clips 203 are disposed in a weight balanced manner about each side of the rear face 211. Optional stress relief clip 207 is hinged about a single point so that it may be selectively engaged and disengaged. Three additional ports are included on the opposite side face including USB port 208, SVGA output connector 209 and IEEE1394 port 210.

The preferred and optimumly preferred embodiments of the present invention have been described herein and shown in the accompanying drawings to illustrate the underlying principles of the invention, but it is to be understood that numerous modification and ramifications may be made without departing from the spirit or scope of this invention.

We claim:

1) A computer system comprising:
A mobile holster;
A user supported wearable computer;
A first connection means for electrically connecting said computer to said holster;
A second connection means for physically connecting said computer to said holster;
A third connection means for physically connecting said holster to the body of a user;
A fourth connection means for connecting an external display device to said computer system.

2) The computer system of claim 1 wherein said computer system further comprises a removable power supply in said mobile holster.

3) The computer system of claim 1 wherein said third connection means comprises means for attaching said holster to a belt worn about the torso of said user.

4) The computer system of claim 1 wherein said holster is further comprised of a vertical and horizontal member.

5) The computer system of claim 1 wherein said holster increases the number of available ports and amount of available power to said computer when said computer is mated with said holster.

6) The computer system of claim 1 wherein said first physical connection means is substantially reinforced by gravity.

7) The computer system of claim 1 wherein said computer is fully operable as a user supported computer independent of said holster.

8) The computer system of claim 1 wherein said fourth connection means resides on the holster.

9) The computer system of claim 1 wherein said fourth connection means resides on the computer itself.

10) The computer system of claim 1 wherein external display device comprises, body worn display device, neck hung display device, wrist mounted display device, belt mounted display device, hand held display device or other suitable mobile display device.

11) A user supported mobile docking station comprising:
A body comprised of at least one rigid member;
An electrical connector for passing signals and power to a mobile user supported computer when mated with said docking station;
A physical receiving structure for receiving said computer
A fastening structure for fastening said mobile docking station to the body of user.

12) The docking station of claim 11 wherein said body is comprised of a vertical and a horizontal member.

13) The docking station of claim 11 further comprising a removable power supply integral to said docking station.

14) The docking station of claim 11 wherein said docking station provides only ancillary functionality to said computer.

15) The docking station of claim 11 wherein said fastening structure facilitates attachment of said station to a belt worn about the torso of a user.
